(19) United States
(12) Patent Application Publication
(10) Pub. No.: US 2024/0005018 A1
(43) Pub. Date: Jan. 4, 2024

(54) System and Method for Improving the Efficiency in Vehicular Data Access While Maintaining Data Security

(71) Applicant: Bayerische Motoren Werke Aktiengesellschaft, Muenchen (DE)

(72) Inventor: Adnan BEKAN, Muenchen (DE)

(21) Appl. No.: 18/036,929

(22) PCT Filed: Dec. 16, 2020
(86) PCT No.: PCT/EP2020/086452

§ 371 Date: May 15, 2023

(51) Int. Cl. G06F 21/62

(52) U.S. Cl. CPC G06F 21/6218

(57) ABSTRACT

Methods and systems for improving the efficiency in vehicular data access are provided. A data provider is configured to provide vehicular data related to a vehicle. A data consumer is configured to access vehicular data from the data provider. A data controller is configured to manage data access between the data consumer and the data provider according to access control rules with respect to the vehicle. The data access is managed based on a verification of a type of data the data consumer is allowed access from the data provider and a privacy data flow that is separate from a data flow of the vehicular data between the data provider and the data consumer.

### BACKGROUND AND SUMMARY OF THE INVENTION

The present subject matter relates to a system and method for improving the efficiency in in-vehicle data access while maintaining data security.

A heterogeneous application programming interface (API)-Services and/or microservices can be integrated into one single API-Point. As used herein, an API/API-Service can be understood as a set of subroutine definitions, communication protocols and tools for a service and defines standardized actions that can be requested for that particular service. In this way, a standardized interface to external applications can be provided. A microservice is the structuring of an application as a collection of loosely coupled services. In order to provide a single API-Point for a plurality of API-Services and/or microservices, a gateway is introduced to provide/introduce privacy methods and/or access methods to each of the API-Services and/or microservices, respectively. Privacy methods and/or access methods comprise, for example, access policies with respect to each of the API-Service and/or microservice. One drawback of this approach is the fact that each request is processed by the gateway before it is forwarded to the respective API-Service(s) and/or microservice(s), where each request needs to be processed again. This leads towards an extensive computational overhead being especially in the vehicular context a major drawback. In particular, more and more applications are available in each modern vehicle. Further, several data privacy regulations, e.g. the General Data Protection Regulation (GDPR) being a European Union-law on data protection and privacy in the European Union needs to be met, where data access to vehicle-related data needs to be dynamically and transparently regulated based on the vehicle user's settings.

Therefore, it is an object of the present subject matter to provide more efficient data accessing techniques with respect to vehicle data in a vehicle eco system while maintaining data security and data privacy.

This problem is solved by the independent claims. Preferred embodiments are described in the dependent claims.

According to a first aspect of the present subject matter, a system for improving the efficiency in vehicular data accessing techniques is provided. The system comprises:
a data provider operable to provide vehicular data, wherein the vehicular data is data related to a vehicle;
a data consumer operable to access vehicular data from the data producer; and
a data controller operable to manage data access between the data consumer and the data provider,
wherein the data controller is operable to manage the data access according to access control settings with respect to the vehicle; wherein the data access management comprises a verification of the type of data the data consumer is allowed access from the data provider; and
wherein the data access management is performed via a privacy data flow that is separated from a data flow of the vehicular data between the data provider and the data consumer.

According to an embodiment, the data controller enforces data access restrictions using digital certificates.

According to a further embodiment, a user of the vehicle can dynamically define access restrictions to the vehicular data with respect to the data consumer via the data controller.

According to another aspect of the present subject matter, a computer-implemented method for improving the efficiency in vehicular data access is provided. The method includes the steps of:
managing, via a data controller, data access between a data consumer and a data provider;
   wherein the data provider is operable to provide vehicular data, wherein the vehicular data is data related to a vehicle;
   wherein the data consumer is operable to access vehicular data from the data provider; and
   wherein the data controller is operable to manage the data access according to access control rules with respect to the vehicle; wherein the data access management comprises a verification of the type of data the data consumer is allowed access from the data provider; and
   wherein the data access management is performed via a privacy data flow that is separated from a data flow of the vehicular data between the data provider and the data consumer.

According to an embodiment, the data controller enforces data access restrictions using digital certificates.

According to a further embodiment, a user of the vehicle can dynamically define access restrictions to the vehicular data with respect to the data consumer via the data controller.

### BRIEF DESCRIPTION OF THE DRAWINGS

FIG. 1 shows a schematic view of a system for data access according to the state of the art;

FIG. 2 shows a schematic view of a system for improving the efficiency in data access;

FIG. 3 shows a more detailed schematic view of a system for improving the efficiency in vehicular data access;

FIG. 4 shows a sequence diagram of a system for improving the efficiency in vehicular data access whiles securing data security;

FIG. 5 illustrates a process of a method for improving the efficiency in vehicular data access.

### DETAILED DESCRIPTION

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

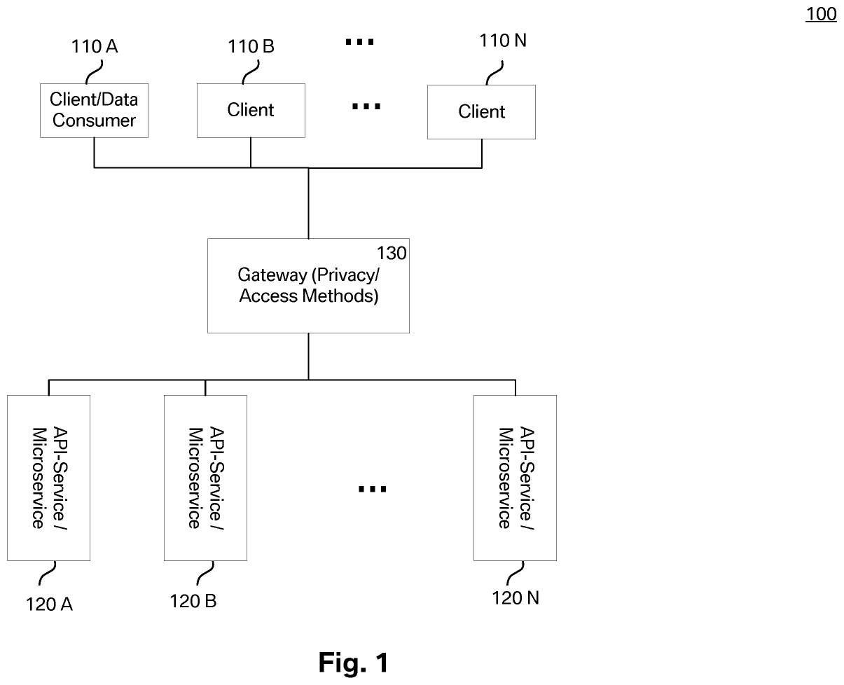

FIG. 1 shows a schematic view of a system 100 for data access according to the state of the art.

The system comprises at least one client/data consumer 110 A, 110 B, . . . , 110 N, a gateway/API-gateway 130 and at least one API service/microservice 120 A, 120 B, . . . , 120N.

As used herein, an API/API-Service 120 A, 120 B, . . . 120 N is a set of subroutine definitions, communication protocols and tools for a service and defines standardized actions (e.g. data access) that can be requested for that service. In this way, a standardized interface to an external application can be provided. A microservice is the structuring of an application as a collection of loosely coupled services. In order to provide a single API-Point for a plurality of API-Services and/or microservices, gateway (API-gateway) is introduced to provide/introduce privacy methods and/or access methods to each of the API-Services and/or microservices, respectively. Privacy methods and/or access methods comprise by way of example access policies with respect to each of the API-Service and/or microservice—for example rules securing the General Data Protection Regulation (GDPR) of the European Union. The gateway (API gateway) 130 is a module that is placed in front of an API from an architectural point of view. It is the single entry-point for defined API services/microservices 120 A, 120 B, . . . , 120N and enforces data security and data access rules. A client/data consumer 110 A, 110 B, . . . , 110 N is a client accessing data from one or more API services/microservices 120 A, 120 B, . . . , 120N.

Each request from each client 110 A, 110 B, . . . , 110 N is directed towards the API-gateway 130. For each request, the API-gateway 130 determines which API Services/microservices are needed for the respective requests. Further, privacy and/or access rules are enforced.

The drawback of this architectural design is, that each request processed by the API-Gateway 130 before it is forwarded to the subsystem(s) 120 A, 120B, . . . , 120N. There, the processing of e.g. the request headers needs to take place again.

This leads to a huge computational effort in order to generate the response to the received request. Further, the API-Gateway 130 is a bottleneck in the sense of a client-server-paradigm, since not only the privacy rules and/or access rules of each API-Service/microservice are enforced, but also the data flow is realized via the API-Gateway.

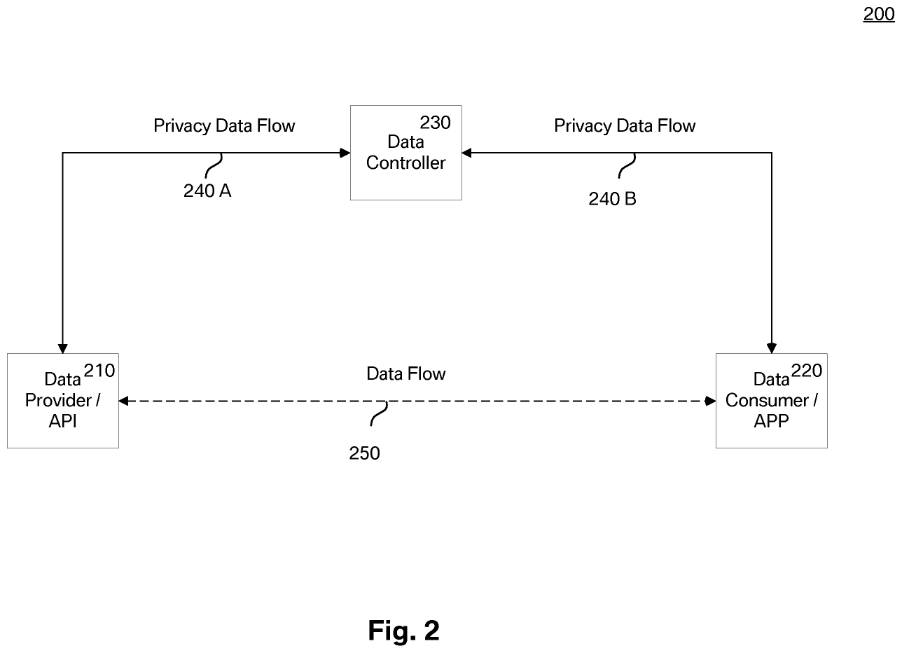

FIG. 2 shows a schematic view of a system 200 for improving the efficiency in data access according to the present subject matter.

The system 200 comprises at least one API-application/microapplication 210, which will herein also be referred to as data provider 210. The system 200 further comprises at least one client/data consumer 220, which will be herein also referred to as data consumer 220. Further, the system comprises a data controller 230. The data controller 230 is operable to manage the data access between the data consumer 220 and the data provider 210. Managing the data access comprises a verification of the type of data the data consumer 220 is allowed access from the data provider 210 by the data controller 230. The API-application/microapplication 210 may be a Representational State Transfer (REST)—API.

REST is a software architectural style that defines a set of constraints to be used for creating Web services. Web services that conform to the REST architectural style, called RESTful Web services, provide interoperability between computer systems on the interne. RESTful Web services allow the requesting systems to access and manipulate textual representations of Web resources by using a uniform and predefined set of stateless operations. Other kinds of Web services, such as SOAP Web services, expose their own arbitrary sets of operations.

Further, Management of data access by the data controller 230 comprises enforcing access control rules. Additionally or alternatively, management of data access comprises enforcing data security techniques, e.g. encryption of data.

Data that is exchanged between data consumer 220 and data controller 230 is a separate data flow called privacy data flow 240B. Analogously, data that is exchanged between data provider 210 and data controller 230 is a separate privacy data flow 240 A. The actual data flow—once the data access management is enforced—is a direct data flow 250 between data provider 210 and data consumer 220.

Each data provider 210 can use the privacy data flow 240A for obtaining a digital certificate in the sense of a public key infrastructure for safe communication from the data controller 230 and for integrating a library to the data controller 230.

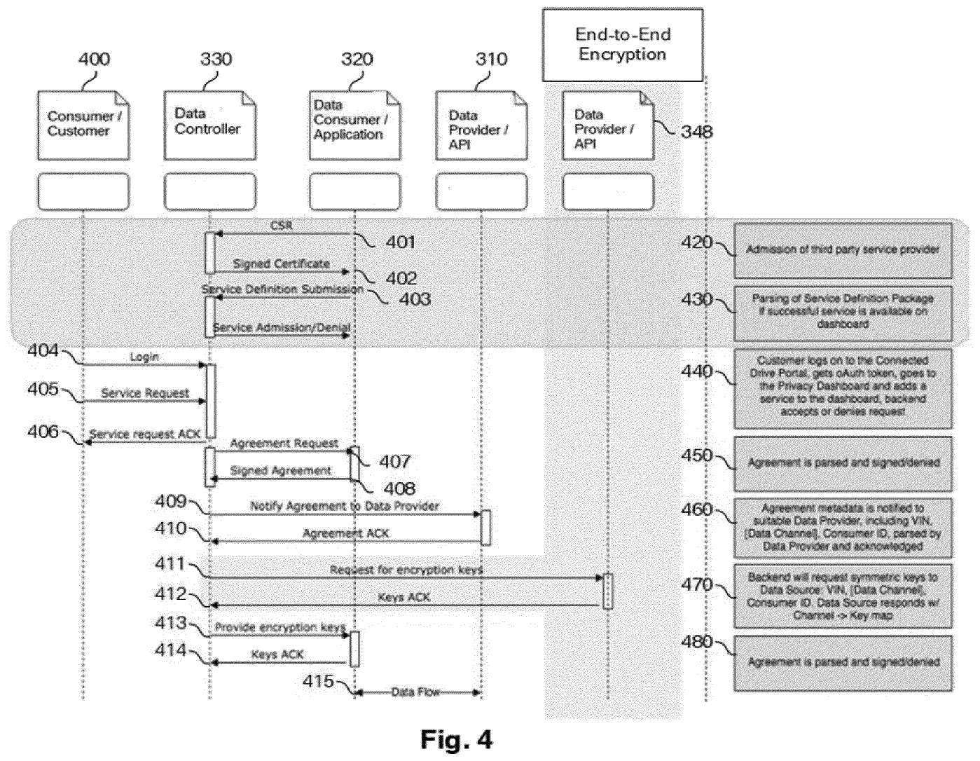

Further, each data consumer 220 needs to obtain a digital certificate in the sense of a public key infrastructure from the data controller 230 for safe communication via the privacy data flow 240B. To do so, each data consumer 220 needs to provide a specification comprising a specification of which type of data is requested from which specific one or more data providers 210 (service definition package as explained in more detail with respect to FIG. 4 below) to the data controller 230. This specification is attached to the certificate by the data controller 230. Moreover, the type of data that needs approval from an owner/user 400 of a vehicle (not shown), is tagged as individual-approval-enforced data, which is also attached to the certificate by the data controller 230 (which is explained in more details in steps 404, 405 and 406 with reference to FIG. 4 below). In other words, privacy-related vehicular data, e.g. data with respect to vehicle speed, . . . etc. can only be accessed if the data provider—which may be part of the vehicle or stored in a backend-server—has an approval from the owner/user 400 of the vehicle.

Accordingly, the communication and synchronization of the data consumer 220 and data producer 210 is realized via privacy flow 240B and 240 A, respectively, using the data controller 230. This enables that each owner/user of each vehicle can perform a customer request that is logged by the data controller 230. By way of example, the customer request (steps 404, 405, 406 as explained in more detail with reference to FIG. 4 below) can comprise authorization- and/or restriction-requests for each data consumer 220 and/or data provider 210, respectively, e.g. “remove my personal data stored at data provider 210” and/or “share all my data with the data consumer 220” and/or “do not permit access to data consumer 220” etc. These examples are merely non-limiting examples for a variety of very flexible and scalable access restrictions with respect to data consumers 220 and data providers 210.

The data controller 230 is further operable to support the data provider 210 as RESTful API application/microapplication, while preventing the data consumer 220 from accessing unauthorized data. To do so, the data elements consumed by the data consumer 220 from a RESTful data provider is stored in a rule set. The rule set defines a set of data elements the data consumer 220 is allowed to access from the data provider 210. The rule set for accessing data by the data consumer 220 from the data provider 210 may be initially agreed.

An exemplary rule set of data elements that may be request by the data consumer 220 from the RESTful data provider 210 may be the following:

```
{
    vehicle(id: “abc”) {
      vehicleIdentification{
            vin{
                value
            }
    }
    cabin{
      infotainment{
        navigation{
            currentLocation{
                latitude{
                  value,
                  timestamp
                  }
                }
              }
            }
          }
    }
  }
```

In this exemplary rule set/possible query, the id of the vehicle is variable and not taken as permanent part of the query.

A hash value for the initially agreed rule set may be generated by the data controller 230 and stored. For each data request from the data consumer 220, a hash value of the data requested by the data request 220 (cf. exemplary data request corresponding to a rule set) needs to be calculated. Only if the calculated hash value matches the hash value of the originally identified rule set, data access is allowed. Otherwise, data access is denied.

Advantageously, a RESTful API-application/microapplication 210 is supported and the query consisting of a set of queries to single data elements can be verified in a single step, whereas conventionally, each data element that is part of the query of the data consumer needs to be verified separately. Hence, the efficiency in processing

Advantageously, each library provided by each data provider 210 can be integrated as middleware for any type of data flow between any data provider 210 and data consumer 220, respectively and defines safe communication via privacy flow 240 A, 240 B, respectively.

Once data providers 220 and data consumers 230 are integrated to the data controller 230 by way of registration and digital certificates, the data controller 230 informs the data consumers 220 about data privacy and data security enforcements.

Data consumers 220 hence inform each data owner (i.e. the user 400 of the vehicle 340) about data usage and their results, which are sent back using the privacy flow 240 B. Hence, reasonable protection of personal data according to the GDPR of the European Union can be enforced whilst minimizing computational effort. In other words, a single control point of person-related or customer-related data is provided by the data controller 230. Further, the data controller 230 provides an additional layer of verification of data processors 220 from third party—providers is established. Data is labelled (licensed) at each data provider 210. By implementing the data controller 230, data security for real-time data and historical data is introduced by design. The data controller 230 can enforce selective data access by data consumers 220 per data stream. Moreover, the data controller 230 verifies each data provider 210 and data consumer 220 against the official Certificate Authority (CA), which ensures data security.

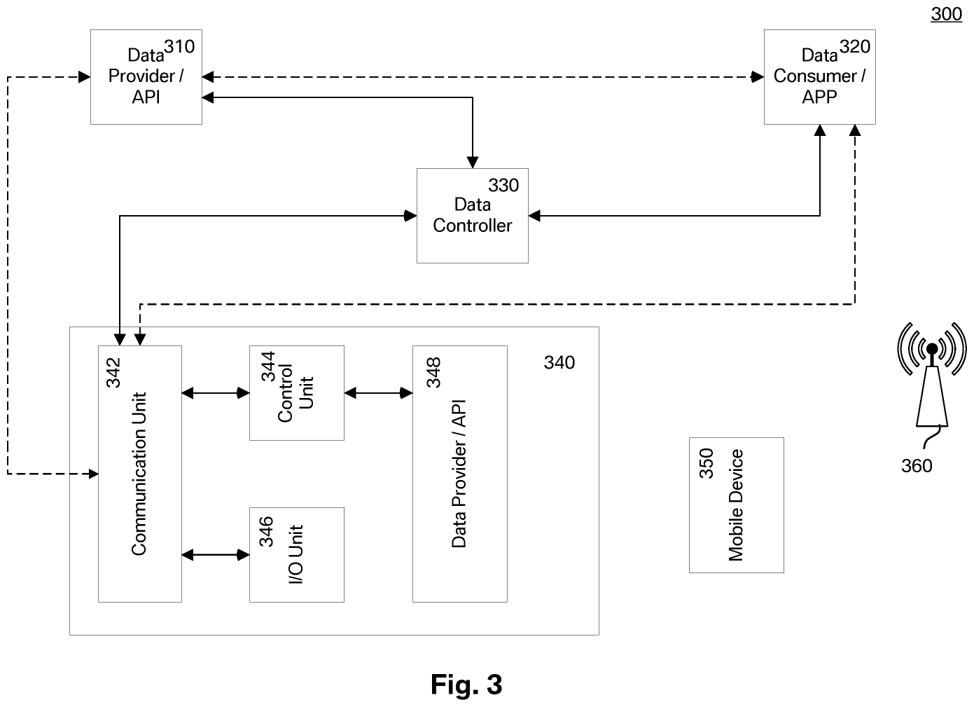

The process as described with respect to FIG. 2 will be explained in more detail with respect to FIGS. 3 and 4 below.

FIG. 3 shows an exemplary schematic, more detailed view of a system 300 shows a more view of a system for improving the efficiency in vehicular data access. The system 300 comprises the components of the system 200 as described with respect to FIG. 2. Accordingly, with respect to said components, it is referred to the description provided with respect to FIG. 2 above.

FIG. 3 illustrates the concept of data providers 210, 310, 348, data consumers 220, 320 and the data controller 230, 330 in a vehicular context.

The data provider 310, 348 may be a data provider 310 external of a vehicle 340. For example, the data provider 310 may be a backend-server or part of a backend server. The (backend server comprising the) data provider 310 may receive and store data from the vehicle 340. The data received from the vehicle 340 may comprise vehicle-related data, e.g. position coordinates (e.g. received by a Global Positioning Component inside the vehicle), vehicle speed data, vehicle sensor data, vehicle diagnostics data, etc. Additionally or alternatively, the data provider 310, 348 may be an in-vehicle data provider 348 that may be a component receiving and storing vehicle-related data as outlined above. The communication between the data provider 348 and the data controller 330 can be managed via an electronic control unit 344 that may be operable to manage data security settings within the vehicle 340. For example, a user of the vehicle 340 may provide via an Input/Output (I/O)-Unit 346 specific settings with respect to data security and or privacy. The user of the vehicle 340 can dynamically provide data security rules with respect to each external data provider 310 (e.g. whether and which data may be received and stored from the vehicle 340, whether data are to be deleted, etc.) and with respect to each data consumer 320 (e.g. whether and which data may be consumed and processed). Furthermore, the data controller 330 notifies the user with respect to each data provider 310 and data consumer 320, which data will be transmitted or accessed, respectively. Additionally or alternatively, the above-mentioned user settings can be provided via an I/O-Unit of the user's mobile device.

The vehicle 340 may comprise an electronic communication unit 342 for data communication capabilities e.g. for data communication between the vehicle and the data provider 310 or between the vehicle 340 and a mobile device 350 related to the vehicle 340 and/or connected with the vehicle 340. The electronic communication unit 342 enables data communication between the vehicle 340 and any other component or device e.g. server, services, mobile devices 350 (e.g. smart phones, tablets) of a user of the vehicle. The data communication may take place via a network 360 (e.g. the mobile network comprising e.g. GSM, EDGE, HSUPA, LTE, 5G, etc.).

The advantages of this approach are pointed out with respect to FIG. 2 above. More details about the privacy data flow with respect to the data providers 210, 310, 348 and the data consumers 220, 320 and the data controller 230, 330 in view of how data privacy and data security are enforced, are explained with respect to FIG. 4 below.

FIG. 4 shows a sequence diagram of the steps performed by a system for improving the efficiency in vehicular data access whiles ensuring data security as pointed out with respect to FIG. 2 and FIG. 3 above.

In a first step 401, the data consumer 220, 320 sends a certificate signing request, CSR, in the sense of the public key infrastructure, PKI, towards the data controller 230, 330.

In a next step 402, the data consumer 220, 320 receives a signed certificate which is a digital identity certificate, from the data controller 230, 330.

These two steps can be summarized as admission of the data consumer 420.

In a next step 403, the data consumer 220, 320 sends a service definition submission/service definition package towards the data controller 230, 330. The service definition submission comprises details about the type of data the data consumer 220, 330 will consumer, privacy policy/policies, terms and conditions of the data controller 230, 330, etc.

The data controller 230, 330 then parses the service definition submission/service definition package and performs a check whether said data consumer 230, 330 is admitted towards consuming the requested data and/or whether the privacy policy/policies is/are valid and/or whether the terms and conditions are valid (Step 430). If the check is positive, the data consumer 220, 320 receives a service admission from the data controller 230, 330, otherwise it receives a service denial.

The data received from the service definition submission/service definition package may be stored in the certificate or in connection to the certificate received from the data controller 230, 330.

In a next step 404, a consumer/customer 400, which may be an owner or user of a vehicle 340, logs into the system comprising the data controller 230, 330. This may be done via the I/O Unit 346 of the vehicle and/or via an I/O Unit of the mobile device 350 which is used by the consumer/customer 400 and connected to the vehicle.

The consumer/customer 404 further executes a service request in step 405 for a service which may be a mobile, in-vehicle 340 web application and/or any application related to the vehicle.

In a further step 406, if the service request is valid, the consumer/customer 400 receives an acknowledgement for the service request from the data controller 230, 330.

In other words, the consumer/customer 400 logs into the system comprising the data controller 230, 330 and adds a service corresponding to the data consumer 220, 320 to the data controller 230, 330. The data controller 230, 330 then accepts or denies the request (step 440.)

In a further step 407, the data controller 230, 330 sends an agreement request to the data consumer 320, 220. The agreement request comprises data informing the data consumer 220, 320 about the agreement of the consumer/customer 400 that the data consumer 220, 320 may consume the vehicle-related data of the consumer/customer 400 of the vehicle 340 according to the service definition submission received from the data consumer 220, 320.

In a next step 408, the agreement request received from the data controller 230, 330 is parsed by the data consumer 220, 320 and signed (if there is an agreement) or denied otherwise.

If the data controller 230, 330 receives a signed agreement from the data consumer 220, 320, the data controller sends in a further step 409 an agreement message to the data provider 210, 310 that provides the consumer/customer and vehicle-related data. The agreement message comprises e.g. the vehicle identification number, VIN and/or a data channel to be used for data transmission and/or a customer identification of the consumer/customer 400. The data provider 210, 310 acknowledges the agreement message to the data controller 230, 330 in step 412.

Optionally, a complete end-to-end encryption (symmetrical or asymmetrical encryption) can be enforced if agreed to. For example, if the data provider is an in-vehicle data provider 348, as explained with respect to FIG. 3 above, the data provider 348 and the data consumer 220, 320 may agree upon end-to-end encryption. In this case, the data controller 330 can provide a decryption key to the data consumer 220, 320 in step 413, which he might accept or deny and send a corresponding message to the data controller 230, 330 in step 414. In this way, data security is further enhanced.

In a last step 415, data flow 250 (as explained with reference to FIG. 2 above) between data consumer 220, 320 and data provider 210, 310 takes place.

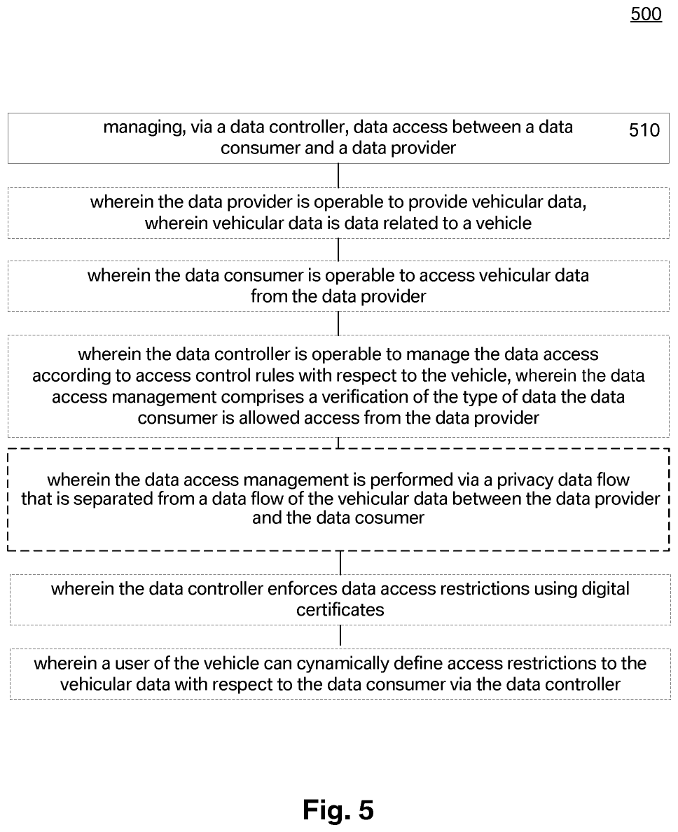

FIG. 5 illustrates a process of a computer-implemented method 500 for improving the efficiency in vehicular data access. The method can be performed by a system 200, 300 as explained in detail with respect to FIGS. 2, 3, and 4 above.

The method comprises the steps of:
managing 510, via a data controller 230, 330, data access between a data consumer 220, 320 and a data provider 210, 310, 348;
   wherein the data provider 210, 310, 348 is operable to provide vehicular data, wherein the vehicular data is data related to a vehicle 340;
   wherein the data consumer 230, 330 is operable to access vehicular data from the data provider 210, 310, 348; and
   wherein the data controller 230, 330 is operable to manage the data access according to access control rules with respect to the vehicle 340; wherein the data access management comprises a verification of the type of data the data consumer is allowed access from the data provider; and
   wherein the data access management is performed via a privacy data flow 240 A, 240 B that is separated from a data flow 250 of the vehicular data between the data provider 210, 310, 348 and the data consumer 220, 320.

The data controller 230, 330 may enforce data access restrictions using digital certificates.

A user of the vehicle 340 may dynamically define access restrictions to the vehicular data with respect to the data consumer 220, 320 via the data controller 230, 330.

1.-6. (canceled)

7. A system for improving the efficiency in vehicular data access, comprising:
a data provider configured to provide vehicular data related to a vehicle;
a data consumer configured to access vehicular data from the data provider; and
a data controller configured to:
manage data access between the data consumer and the data provider according to access control rules with respect to the vehicle based on:
a verification of a type of data the data consumer is allowed access from the data provider, and
a privacy data flow that is separate from a data flow of the vehicular data between the data provider and the data consumer.

8. The system according to claim 7, wherein the data controller enforces data access restrictions using digital certificates.

9. The system according to claim 7, wherein a user of the vehicle can dynamically define access restrictions to the vehicular data with respect to the data consumer via the data controller.

10. A computer-implemented method for improving the efficiency in vehicular data access, comprising:
managing, by a data controller, data access between a data consumer and a data provider by:
providing, by the data provider, vehicular data related to a vehicle, and
accessing, by the data consumer, the vehicular data from the data provider,
wherein
the data controller manages the data access according to access control rules with respect to the vehicle by:
verifying a type of data the data consumer is allowed access from the data provider, and
performing a privacy data flow that is separate from a data flow of the vehicular data between the data provider and the data consumer.

11. The method according to claim 10, wherein the data controller enforces data access restrictions using digital certificates.

12. The method according to claim 10, wherein a user of the vehicle can dynamically define access restrictions to the vehicular data with respect to the data consumer via the data controller.
